(19) United States
(12) Patent Application Publication
(10) Pub. No.: US 2008/0234019 A1
(43) Pub. Date: Sep. 25, 2008

(54) COMBINE HARVESTER WITH SUCTION FAN

(76) Inventors: Stefan Teroerde, Warendorf (DE); Rainer Bellmann, Harsewinkel (DE); Joachim Baumgarten, Beelen (DE); Ulrich Claes, Dissen (DE); Waldemar Schulz, Paderborn (DE); Martin Niermann, Harsewinkel (DE)

Correspondence Address: Striker, Striker & Stenby, 103 East Neck Road, Huntington, NY, 11743, US

(21) Appl. No.: 12/061,919

(22) Filed: Apr. 3, 2008

Related U.S. Application Data
(63) Continuation of application No. 11/560,183, filed on Nov. 15, 2006.

(30) Foreign Application Priority Data
Nov. 23, 2005 (DE) 10 2005 056 115.2

(51) Int. Cl. A01F 12/44

(52) U.S. Cl. 460/100

(57) ABSTRACT

A self-propelled combine harvester has a machine housing, and a suction fan configured so as to convey at least one stream of material out of the machine housing, so that it causes the stream of material to be distributed across a spreading width.

### CROSS-REFERENCE TO A RELATED APPLICATION

The invention described and claimed herein is also described in German Patent Application DE 10 2005 056 115.2 filed on Nov. 23, 2005. This German Patent Application, whose subject matter is incorporated here by reference, provides the basis for a claim of priority of invention under 35 U.S.C. 119(a)-(d).

This application is a Continuation of U.S. patent application Ser. No. 11/560,183 filed Nov. 16, 2006.

### BACKGROUND OF THE INVENTION

The present invention relates to a self-propelled combine harvester with a suction fan.

Publication DE 26 20 875 makes known a combine harvester with a grain-cleaning device composed of two vertically stacked sieves and a forced draught fan, which blows from diagonally below through the sieves. A suction fan with a chaff suction box is also located over the uppermost sieve in the rear region of the machine housing. The chaff suction box intensifies the blow-through effect of the forced draught fan and draws in a portion of the chaff moving over the uppermost sieve and conveys it through the suction fan and out of the combine harvester. The chaff falls out of the nozzle directly onto the ground behind the combine harvester.

The disadvantage of this known suction fan is the fact that the energy in the intake air flow that is created is used only to transport a quantity of crop material out of the machine housing into the suction fan, and two separate compressed air cleaning systems must be provided for the cleaning device.

### SUMMARY OF THE INVENTION

The object of the present invention, therefore, is to avoid the disadvantages of the related art.

More particularly, it is an object of the present invention to provide a suction fan which can convey a stream of material, which is composed mainly of chaff, out of the cleaning device and spread it on the ground.

In keeping with these objects and with others which will become apparent hereinafter, one feature of the present invention resides, briefly stated, in a combine harvester, comprising a machine housing; and a suction fan, said suction fan being configured so as to convey at least one stream of material out of said machine housing, said suction fan housing and so that it causes the stream of material to be distributed across a spreading width.

Due to the fact that the suction fan also causes the stream of material to be distributed across the spreading width, the energy of the material and compressed air flow exiting the suction fan is utilized further. This has the particular advantage that the number of working units required is reduced, since the suction fan serves both as a suction device and a spreading device.

In an advantageous embodiment of the present invention, at least one cleaning device is assigned to the combine harvester. The suction fan is designed as a cleaning fan, which also causes the stream of material discharged from the cleaning device, at the least, to be spread over the ground. As such, the suction fan fulfills several tasks simultaneously and is therefore used effectively.

In an advantageous refinement of the present invention, a rotating spreader is assigned to the suction fan, and the suction fan transfers the stream of material to the spreader, which causes the stream of material to be spread on the ground, so that the kinetic energy of the stream of material is largely retained when it enters the spreader and can be used to throw the material farther.

In an advantageous embodiment of the present invention, a spreader cover is assigned to the suction fan, and the suction fan transfers the stream of material to the spreader cover, which causes the stream of material to be spread on the ground. The stream of material is thereby deflected to different extents, to evenly distribute the stream of material on the ground.

When the spreader is set into rotational motion actively or passively, the friction between the impacting stream of material and the spreader can be reduced, thereby reducing a “braking” of the stream of material by the spreader. An active drive also allows the exiting material to be accelerated further, which allows even greater spreading widths to be attained.

Due to the fact that the suction fan is composed of a large number of suction fan units—each of which is designed as recited in at least one of the Claims 1 through 6—a flow of intake air that is nearly consistent across the entire width of the cleaning device is produced.

In an advantageous embodiment of the present invention, the suction fan includes at least one rotor which rotates in a housing; the housing includes a discharge channel, the orientation of which can be changed, so that the direction of motion of the material flow can be changed.

In an advantageous refinement of the present invention, the discharged channels are driven in an oscillating manner, so that the direction of motion of the material flow is permanently adjustable, to attain an even distribution of the material flow on the ground.

In a further advantageous embodiment of the present invention, the combine harvester includes a straw chopper. A stream of chopped material produced by the straw chopper is conveyed to the suction fan, so that the chopped-material flow and the chaff can be conveyed together by the suction fan into the spreader, which spreads it.

In an advantageous embodiment of the present invention, the material stream exiting the suction fan is combined with the chopped-material stream exiting the straw chopper and is transferred along with it to a spreader. As such, before it is spread, the chopped-material flow is accelerated by the stream of material exiting the suction fan, and the streams of material are mixed before they are spread.

Due to the fact that the suction fan draws in at least one air flow through at least one blower air intake into the machine housing, the direction of flow and point of entry of the intake air flow are oriented such that the air flow conveys at least part of a material flow separated by the cleaning device into the suction fan.

Due to the fact that the cleaning device separates the grains from the specifically lighterweight non-grain components—the intake air flow conveying at least a portion of the non-grain components separated by the cleaning device into the suction fan—the load on the upper sieve is eliminated, thereby optimizing the cleaning effect of the cleaning device.

In a further refinement of the present invention, the cleaning device includes several vertically stacked sieves, and the intake air flow drawn in through the blower air intakes flows through the sieves from the bottom to the top, so that the crop material guided over the sieves is loosened, and the specifically lighterweight crop material components are separated out of the crop material.

### BRIEF DESCRIPTION OF THE DRAWINGS

FIG. 1 shows a side view of a combine harvester with an inventive suction fan,

FIG. 2 shows a rear section of a top view of a combine harvester in FIG. 1, with a further exemplary embodiment of an inventive suction fan,

FIG. 3 shows a section of a side view of the combine harvester in FIG. 1, with a further exemplary embodiment of an inventive suction fan.

### DESCRIPTION OF THE PREFERRED EMBODIMENTS

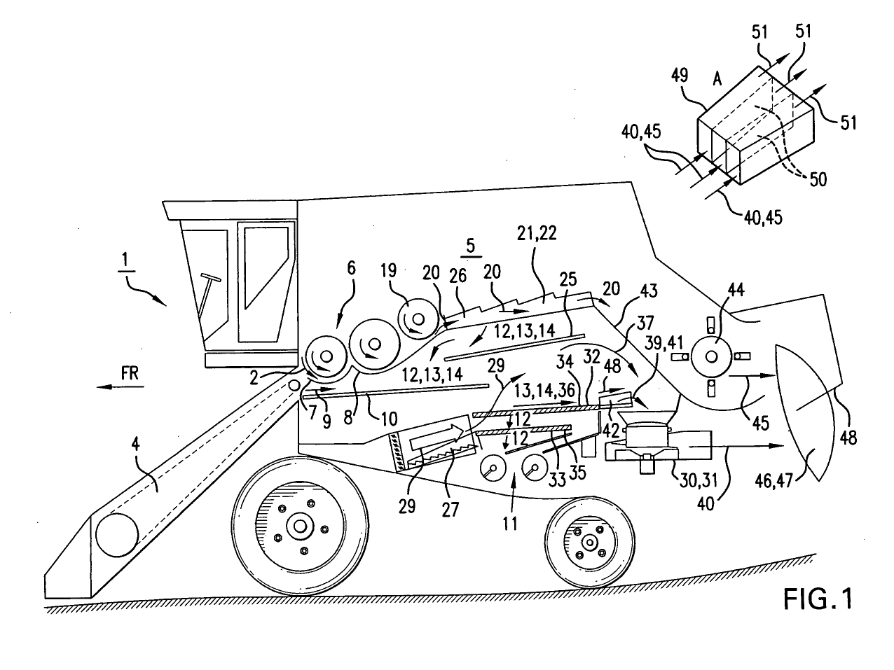

FIG. 1 shows an agricultural working machine designed as a combine harvester 1. Crop material 2 is initially taken up by header 3, which conveys crop material 2 to a feed rake 4 located on the front of combine harvester 1. Feed rake 4 transfers crop material 2 to threshing mechanism 6 located in machine housing 5. Threshing mechanism 6 processes crop material 2 intensively, so that the grain is released from crop material 2. A grain-chaff mixture 9, which is composed mainly of grain, is separated at threshing and separating grates 7, 8 of threshing mechanism 6, travels via grain pan 10 to cleaning device 11, to separate grain 12 from the non-grain components, i.e., stalk parts 13 and chaff parts 14.

In the rear region, an impeller 19 which rotates in the counterclockwise direction is assigned to threshing mechanism 6; impeller 19 catches crop material 20—which is composed mainly of threshed-out stalks—and conveys it to a separating unit 21, e.g., a tray-type shaker 22, which conveys the stream of material 20 into the rear region of combine harvester 1.

Any grains 12 still present in material flow 20 and any short straw 13 and chaff 14 are separated out by falling through tray-type shaker 22—which includes sieve openings 26—to a return pan 25. Return pan 25 transports grain 12, short straw 13, and chaff 14 to grain pan 10.

Grain 12, short straw 13, and chaff 14 ultimately reach cleaning device 11—also via grain pan 10—in which grain 12 is separated from short straw 13 and chaff 14.

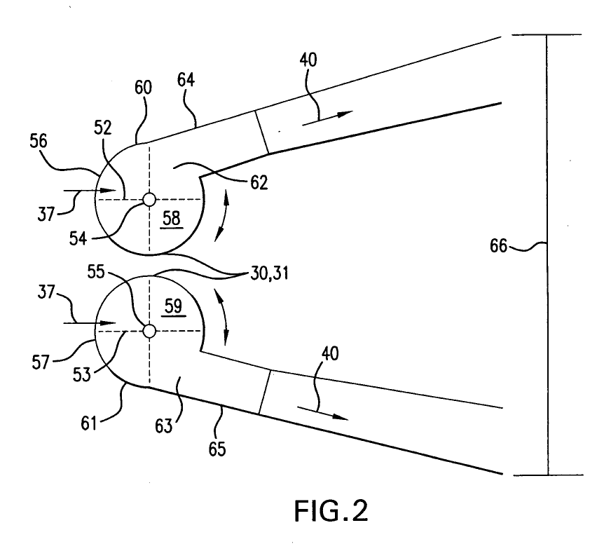

A cleaning fan 31 assigned to cleaning device 11 is located in the rear region of machine housing 5 of combine harvester 1. Cleaning fan 31 is designed as a suction fan 30 and, according to the present invention, conveys a stream of material 37 out of machine housing 5 and simultaneously causes material stream 37 to be distributed over a spreading width 66 (see FIG. 2) on the ground.

To this end, suction fan 30 draws in an intake air flow 29 through a blower air intake 27 into machine housing 5. Blower air intake 27 is located at the rear end of combine harvester 1 below grain pan 10 in front of sieves 34, 35, so that intake air flow 29 flows from bottom to top through sieve openings 32, 33 of upper sieve 34 and lower sieve 35 of cleaning device 11, by way of which it loosens crop material 36 conveyed via sieves 34, 35 into the rear region of combine harvester 1 and ensures that specifically lighterweight chaff and short-straw portions 13, 14 are separated out, while crop grains 12, which are heavier, fall through sieve openings 32, 33.

At least a portion of specifically lighterweight chaff and short-straw portions 13, 14, which, taken together, form stream of material 37, and which are located between return pan 25 and upper sieve 34, are suctioned by suction fan 30 out of machine housing 5. Suction fan 30 transfers chaff-air flow 40, which contains material flow 37 and which exits suction fan 30, to a spreader 47, which is located downstream of suction fan 30 and which will be discussed in detail below. Spreader 47 causes material flow 37 to be distributed on the ground in a spreading width 66 (see FIG. 2).

Sieve overflow 41, which is composed of chaff 39, and which does not fall through upper sieve 34, also reaches suction fan 30, via a conveyor element 42. A threshed-out straw-chaff mixture 20 and a certain percentage of waste grain travel via tray-type shaker 22 to the rear end of combine harvester 1 and slide on a guide plate 43 into straw chopper 44, in which straw-chaff mixture 20 is chopped up and accelerated. In the exemplary embodiment shown, straw chopper 44 is located—in the direction of travel FR of combine harvester 1—behind suction fan 30 and, in the vertical direction, above suction fan 30.

Spreader 47 is located in the trajectories of chopped-material flow 45 which exits freely from straw chopper 44, and chaff-air flow 40 which exits freely from suction fan 30. In the exemplary embodiment shown, spreader 47 is designed as a hemispherical dish 46, which is mounted on the outside of machine housing 5 such that it can rotate around an axis of rotation 48. Flows 40, 45 which strike the interior of hemispherical dish 46 are deflected by hemispherical dish 46 and are spread on the ground. The direction and intensity of the deflection depends on the point of impact and the orientation of chopped-material flow 45, chaff-air flow 40, and hemispherical dish 46. Hemispherical dish 46 can be set into rotational motion around axis of rotation 48 actively via a separate drive, or passively by chaff-air flow 40 or chopped-material flow 45.

Instead of spreader 47, a distributor cover 49—as shown in Section A of FIG. 1—can be located in the rear region of the combine harvester. Chopped-material flow 45 which exits freely from straw chopper 44, and chaff-air flow 40 which exits suction fan 30 are directed to spreader cover 49. Material flows 40, 45 are subdivided by several guide plates 50 located in spreader cover 49 into sub-material flows 51, which are deflected into different directions, so that material flows 40, 45 are spread on the ground.

FIG. 2 shows the rear section of a top view of a combine harvester with a further exemplary embodiment of an inventive suction fan 30. Suction fan 30 is composed of two adjacent rotors 52, 53, which rotate in opposite directions around parallel axes of rotation 54, 55. Each rotor 52, 53 is located in a housing 56, 57 which includes a cover 58, 59 on the underside, and a wall 60, 61 which surrounds particular rotor 52, 53. An outlet opening 62, 63 is provided in wall 60, 61, with which a discharge channel 64, 65 is radially connected. Housings 56, 57 are rotatable around axes of rotation 54, 55 of associated rotor 52, 53, thereby enabling the position of discharge channel 64, 65 to be adjusted.

Suction fan 30 conveys material flow 37 through discharge channels 64, 65 and out of machine housing 5, and spreads chaff-air flow 40 which exits suction fan 30 in a spreading width 66 on the ground, according to the present invention. Spreading width 66 of chaff-air flow 40 can be modified by changing the orientation of discharge channels 64, 65 of housings 56, 57. It is feasible that housings 56, 57 are driven in an oscillating manner, in order to continually change the orientation of discharge channels 64, 65 and, therefore, spreading width 66. It is feasible that chopped-material flow 45 which exits straw chopper 44 is also conveyed into suction fan 30, and suction fan 30 transfers material flow 37 together with chopped-material flow 45 to a spreader 47, which spreads chaff-air-chopped-material flow 71 which exits suction fan 30 in a spreading width 66 on the ground.

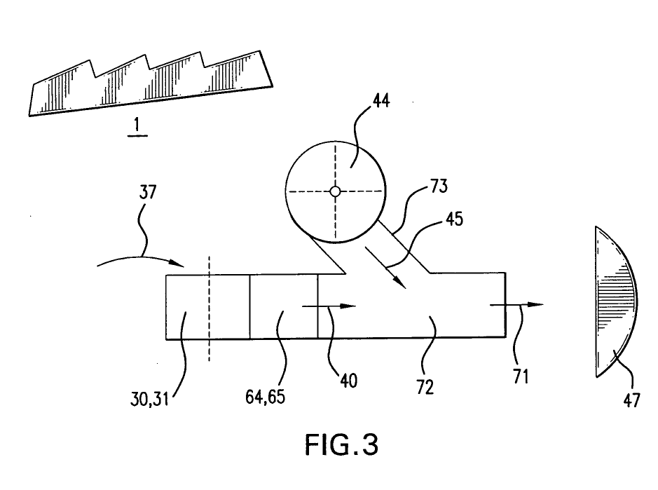

A further exemplary embodiment with an inventive suction fan 30 is shown in FIG. 3.

In the exemplary embodiment shown, straw chopper 44 is located—in the direction of travel FR of combine harvester 1—behind suction fan 30 and above suction fan 30. Chaff-air flow 40 which exits suction fan 30 nearly horizontally against direction of travel FR of combine harvester 1 is guided through an ejector channel 72, which is located downstream of discharge channel 64, 65 of suction fan 30. A feed funnel 73 abuts ejector channel 72 in the center. Via feed funnel 73, chopped-material flow 45, which exits straw chopper 44 diagonally downward and radially against direction of travel FR of combine harvester 1, is directed to ejector channel 72, so that both material flows 40, 45 are combined inside ejector channel 72.

Chaff-air flow 40 accelerates chopped-material flow 45 and retains the kinetic energy introduced by straw chopper 44. To this end, the speed of chaff-air flow 40 must be greater than the speed of chopped-material flow 45, so that chopped-material flow 45 is carried along by chaff-air flow 40 in accordance with the mode of operation of an ejector/injector. Chaff-chopped-material flow 72 produced by combining the two material flows 40, 45 and which exits ejector channel 72 is directed to a spreader 47 located downstream of ejector channel 72. Spreader 47 distributes chaff-chopped-material flow 71 in the spreading width on the field. By increasing the speed of chopped-material flow 45, it is possible for spreader 47 to throw material further, which results in a larger spreading width.

It is within the scope of the ability of one skilled in the art to modify the exemplary embodiments described in a manner not presented, or to use them in other machines to achieve the effects described, without leaving the framework of the invention.

It will be understood that each of the elements described above, or two or more together, may also find a useful application in other types of constructions differing from the type described above.

While the invention has been illustrated and described as embodied in a combine harvester with suction fan, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A self-propelled combine harvester, comprising a machine housing; and a suction fan, said suction fan being configured so as to convey at least one stream of material out of said machine housing, so that it causes the stream of material to be distributed across a spreading width.

2. A self-propelled combine harvester as defined in claim 1; and further comprising at least one cleaning device, said suction fan being configured as a cleaning fan and also causing the stream of material to be discharged from said cleaning device and at least to be spread over a ground.

3. A self-propelled combine harvester as defined in claim 1; and further comprising a rotating spreader assigned to said suction fan, said suction fan being configured so as to transfer the stream of material to said spreader, which causes the stream of material to be spread over a ground.

4. A self-propelled combine harvester as defined in claim 1; and further comprising a spreader cover assigned to said suction fan, said suction fan being configured so that it transfers the stream of material to said spreader cover, which causes the stream of material to be spread over a ground.

5. A self-propelled combine harvester as defined in claim 3; and further comprising means for setting said spreader into a rotational motion in a manner selected from the group consisting of actively and passively.

6. A self-propelled combine harvester as defined in claim 1, wherein said suction fan is composed of a plurality of suction fan units, each configured so as to cause the stream of material to be distributed across a spreading width.

7. A self-propelled combine harvester as defined in claim 1, wherein said suction fan includes at least one rotor which rotates in a housing including at least one discharge channel arranged so that an orientation of said discharge channel is changeable.

8. A self-propelled combine harvester as defined in claim 7, wherein said at least one discharge channel is driven in oscillating manner; and further comprising means for driving said at least one discharge channel in an oscillating manner.

9. A self-propelled combine harvester as defined in claim 1; and further comprising a straw chopper which is configured so as to create a chopped-material flow conveyable to said suction fan.

10. A self-propelled combine harvester as defined in claim 9, wherein said straw chopper and said suction fan are arranged so that a stream of material exiting said suction fan is combined with the chopped-material flow exiting said straw chopper and transferred to a spreader.

11. A self-propelled combine harvester as defined in claim 1; and further comprising at least one blower air intake, said suction fan being configured so as to draw in at least one intake air flow through said at least one blower air intake into said machine housing.

12. A self-propelled combine harvester as defined in claim 1; and further comprising a cleaning device which separates grain from specifically light weight non-grain components; and at least one blower air intake through which said suction fan draws in at least one intake air flow that conveys at least some of the non-grain components separated by said cleaning device, into said suction fan.

13. A self-propelled combine harvester as defined in claim 1; and further comprising a cleaning device; and an at least one blower air intake through which at least one intake air flow is drawn by said suction fan, said cleaning device including several stacked sieves, and said intake air flow drawn in through said blower air intake flows through said sieves from bottom to top.
